(19) United States
(12) Patent Application Publication
(10) Pub. No.: US 2019/0090424 A1
(43) Pub. Date: Mar. 28, 2019

(54) Swath Roller Attachment for a Swather Tractor

(71) Applicant: MacDon Industries Ltd., Winnipeg (CA)

(72) Inventors: Jason Strobbe, Winnipeg (CA); Richard Kirkby, Winnipeg (CA); Michael Flintoft, Winnipeg (CA); Neil Gordon Barnett, Winnipeg (CA)

(21) Appl. No.: 15/983,421

(22) Filed: May 18, 2018

Related U.S. Application Data
(63) Continuation of application No. 14/612,444, filed on Feb. 3, 2015, now abandoned.
(60) Provisional application No. 61/972,724, filed on Mar. 31, 2014.

(51) Int. Cl. A01D 43/00; A01D 84/00; A01D 82/02; A01D 34/00; A01D 45/00

(52) U.S. Cl. CPC A01D 43/006; A01D 84/00; A01D 82/02; A01D 45/00; A01D 34/006

(57) ABSTRACT

A swather with a crop cutting header includes a swath roller for rolling on the swath carried on a mounting assembly attached to the tractor frame and a lifting assembly for lifting the roller free from the swath where a control unit is arranged to lift the swath roller to the raised position thereof when the header is raised to the raised position thereof. The control unit also includes a GPS position sensing system so that the roller is lifted at positions determined by the GPS position sensing system. The mounting assembly comprises a mounting frame rigidly attached to the rear walking beam of the tractor so that the mounting frame is held at a set position relative to the tractor determined by a position of the beam so that the swath roller is not pivotally mounted relative to the tractor.

This application is a continuation of application Ser. No. 14/612,444 filed Feb. 3, 2015 which claims the benefit under 35 USC 119 (e) of Provisional Application 61/972,724 filed Mar. 31, 2014.

This invention relates to a swath roller attachment for mounting to a swather tractor for rolling over the swath behind the tractor.

### BACKGROUND OF THE INVENTION

In U.S. Pat. No. 7,077,220 (Dunn) issued Jul. 18, 2006 and assigned to the present Assignees is disclosed a hydrostatic agricultural tractor used as a self-propelled swather tractor. This uses the typical construction for such tractors which has front ground wheels mounted on the frame at fixed angles parallel to each other and parallel to a center line of the frame and rear ground wheels mounted on a respective castor. Each of the front ground wheels is driven by a respective drive motor which allows variable speed in both the first and second directions such that steering of the tractor is effected by a differential in speed between the front wheels with the rear wheels following the steering in a castoring action. A pair of damper cylinders is provided, each connected between a bracket on a rear axle of the frame and a lever in the castor plane of the castor so as to provide a damping force tending to restrict rotation of the respective second wheel about the respective vertical pivot axis with the damping force at a maximum value when the rear wheels are parallel to the center line in either the forward or reverse directions.

Such hydrostatically driven tractors used primarily for swathing are commonly used and readily available. The tractor carries at a forward end on suitable sprung supports a header for cutting standing crop with the crop being transported on the header to a suitable discharge location generally centrally of the tractor for forming a swath in the field from the cut crop.

Such tractors generally include a pair of front wheels just behind the header which are fixed to the frame of the tractor so that they remain at an angle parallel to each other and parallel to a center line of the tractor. The tractor is supported at the rear end by a pair of castor wheels which are attached to a cross axle pivotally connected to the frame at a center horizontal pivot point, commonly known as a walking beam. The axle is supported relative to the ground the castor wheels at the ends of the rear axle so that the wheels trail behind a vertical pivot mount for the wheels and are free to swivel through 360° around the pivot mount.

The front wheels only are driven and are driven in a manner which allows full control in the forward and reverse directions so that steering is effected by a differential speed between the two front wheels with the rear wheels following in the conventional castoring action.

Swath rollers are commonly provided to be towed behind a swather tractor to apply pressure onto the swath as after it is discharged from the rear of the tractor.

An example is shown in Canadian Patent No: 599,761 issued Jun. 14, 1960 by Hellegards which shows a simple cylindrical roller attached behind a towed swather.

Many manufacturers have provided towed swath rollers which comprise a wheeled frame with a forwardly extending hitch pole which attaches to the rear of the swather tractor. One example is shown in a brochure by the present Applicants where a transverse beam carried on the ground wheels has a pair of rearwardly extending arms between which is mounted a metal roller drum. The drum has a cylindrical center section with flared frusto-conical ends. The height of the drum can be adjusted on the frame to adjust the pressure on the swath, depending on the thickness of the swath. The ends of the drum can be closed by circular end plates.

This type of swath roller has achieved considerable success and many have been sold by various manufacturers.

More recently the metal drum has been replaced by a plastic rotationally molded drum. This has advantage that it does not rust and can be manufactured cheaply but it has disadvantages that it slips on the crop and therefore may not properly rotate in a rolling action. Also the drum is very light so that it may not apply the required pressure.

One example of a roller of this type is shown in Canadian Patent Application Serial No: 2,299,185 (Worms) of Koenders published Aug. 23, 2001. This provides longitudinally extending ribs on the drum to aid in causing the drum to properly rotate.

Another example is shown in Canadian Patent No: 2,311,692 (Cresswell) of Bourgault issued Mar. 11, 2003. This shows in FIG. 1 a similar arrangement of towed frame in which the width of the drum can be adjusted. In FIG. 2 is shown a different arrangement in which the roller is carried on a pair of arms extending rearwardly from the rear of the tractor. There are no ground wheels and the height of the drum is adjusted by a winch arrangement which lifts and lowers the drum frame at the rear of the arms. This arrangement manufactured by Free Form Plastics has the disadvantage that the amount of pressure on the swath is dependent only on the weight of the drum and this may be insufficient as the drum is a plastic molded drum.

In view of the disadvantages of this system, Free Form Plastics has developed recently a system in which the winch suspension system is replaced by a pair of double acting cylinders which allow the cylinders to press downwardly on the roller. This is shown in Canadian Patent 2,635,859 (Miller) issued Apr. 19, 2011 to Bourgault Industries.

The disclosures of the above cited documents are incorporated herein by reference.

Swather tractors have in recent years become much larger and more complex with some having independent suspension of the rear wheels. Such tractors are of the type with front wheels which are independently driven to provide a steering action together with castor rear wheels which follow the direction determined by the differential speeds of the front wheels. The towed swath rollers have become inadequate to provide a suitable convenient arrangement for the operator. At the same time there has been an increased demand for swath rolling.

### SUMMARY OF THE INVENTION

It is one object of the invention to provide an improved swath roller.

According to one aspect of the invention there is provided an agricultural tractor comprising:

a tractor frame having a cab;

a header mounted on support members at a forward end of the frame to be moved in a longitudinal working direction across the ground;

the header being arranged in a working position to cut a standing crop and to form a swath of the crop for deposit on the ground behind the tractor;

a first pair of ground wheels mounted on the frame at positions spaced transversely of the frame adjacent the forward end for supporting the tractor adjacent the header;

a second pair of ground wheels mounted on the frame at positions spaced transversely of the frame adjacent a rearward end of the tractor and spaced to allow the passage of the swath between the second pair of wheels;

a swath roller for rolling on the swath;

a mounting assembly for attaching the swath roller to the tractor for forward movement with the tractor;

a lifting assembly for lifting the swath roller upward from the swath so that in a raised position the swath roller is free from the swath for passage over the swath;

wherein the tractor includes a control unit for controlling lifting of the header from the working position to a raised position thereof;

and wherein the control unit is arranged to lift the swath roller to the raised position thereof when the header is raised to the raised position thereof.

Preferably the control unit is arranged for actuating the raising of the header to halt crop cutting for maneuvering of the tractor with the header raised and for lowering the header to return to the working position and the control unit is arranged to raise and lower the swath roller in conjunction with the header.

Preferably there is provided a manually operable control for operation by a driver of the tractor for actuating the raising and lowering of the header by the control unit so that both the header and the swath roller are simultaneously raised and lowered for turning of the tractor.

In one arrangement the swath roller is raised and lowered by a hydraulic valve block to divert oil flow to hydraulic cylinders of the lifting assembly of the swath roller.

Alternatively the swath roller can be raised and lowered by an electric device such as relay triggering electric current to electric actuators of the lifting assembly of the swath roller.

Preferably the control unit includes a GPS position sensing system for actuating the raising of the header to halt crop cutting for maneuvering of the tractor with the header raised and for lowering the header to return to the working position at positions determined by the GPS position sensing system. This can be used in place of the operator controlled system or in addition to it.

Preferably the mounting assembly includes a pair of depending members attached to the mounting assembly at an upper end of the members and carrying the swath roller at a lower end of the members. The arm members can be fixed to the mounting assembly to prevent pivotal or rotatable mounting of the swath roller on the tractor and the depending members can be extendible to raise and lower the swath roller relative to the mounting assembly and hence relative to the tractor.

Preferably the depending members are double or single acting cylinders extendible along their length. However any extendible link system can be used such as levers and cylinders or levers and electric actuators or cables.

Preferably the depending members or cylinders provide a floating action by retracting in response to loads from the swath roller greater than a set value so that the ends of the roller can raise as required as a trip system in the event of impact from the ground or other object.

Preferably the swath roller is directly attached to the mounting assembly without any intervening frame. That is the swath roller preferably includes bearings at each end which are directly attached to the mounting assembly or the roller is carried by an axel carried in the bearings so that again there is no frame structure carrying the roller independent of the mounting assembly.

Preferably the swath roller is carried on a pair of arms rigidly attached to a component of the tractor and extending rearwardly from the tractor so that the arms move with the component and are not rotatably or pivotally mounted relative to the tractor.

Preferably the swath roller is mounted the rear of the tractor behind the rear wheels or it can be mounted underneath the tractor if sufficient clearance is available.

According to a second aspect of the invention there is provided an agricultural tractor comprising:

a tractor frame having a cab;

a header mounted on support members at a forward end of the frame to be moved in a longitudinal working direction across the ground;

the header being arranged in a working position to cut a standing crop and to form a swath of the crop for deposit on the ground behind the tractor;

a first pair of ground wheels mounted on the frame at positions spaced transversely of the frame adjacent the forward end for supporting the tractor adjacent the header;

a second pair of ground wheels mounted on the frame at positions spaced transversely of the frame adjacent a rearward end of the tractor and spaced to allow the passage of the swath between the second pair of wheels;

a swath roller for rolling on the swath;

a mounting assembly for attaching the swath roller to the tractor for forward movement with the tractor;

a lifting assembly for lifting the swath roller upward from the swath so that in a raised position the swath roller is free from the swath for passage over the swath;

wherein there is provided a GPS position sensing system and wherein the lifting assembly for lifting the swath roller is operated at positions determined by the GPS position sensing system.

According to a third aspect of the invention there is provided an agricultural tractor comprising:

a tractor frame having a cab;

a header mounted on support members at a forward end of the frame to be moved in a longitudinal working direction across the ground;

the header being arranged in a working position to cut a standing crop and to form a swath of the crop for deposit on the ground behind the tractor;

a first pair of ground wheels mounted on the frame at positions spaced transversely of the frame adjacent the forward end for supporting the tractor adjacent the header;

a second pair of ground wheels mounted on the frame at positions spaced transversely of the frame adjacent a rearward end of the tractor and spaced to allow the passage of the swath between the second pair of wheels;

a swath roller for rolling on the swath;

a mounting assembly for attaching the swath roller to the tractor for forward movement with the tractor;

a lifting assembly for lifting the swath roller upward from the swath so that in a raised position the swath roller is free from the swath for passage over the swath;

wherein the mounting assembly comprises a mounting frame rigidly attached to a component of the tractor such that the mounting frame is held at a set position relative to the tractor determined by a position of the component so that the swath roller is not pivotally or rotatably mounted relative to the tractor.

Thus the apparatus herein provides a swath roller device that automatically raises or lowers to a pre-determined set height on a windrower tied to the header raise/lower function or GPS system that uses vehicle positioning relative to headlands.

The operation of the swath roller is obtained by software within the machine through electrical software functioning the required mechanisms for a sequence of events to make this function happen.

Through GPS (Global Positioning System) interfaced to the machine:

The GPS system would trigger the mechanisms for a sequence of events to make this function happen.

The mechanisms could be a hydraulic valve block to divert oil flow to hydraulic cylinders to raise and lower drum/roller.

The mechanisms could also be an electric device such as relay triggering electric current to electric actuators to raise and lower drum/roller.

### BRIEF DESCRIPTION OF THE DRAWINGS

One embodiment of the invention will now be described in conjunction with the accompanying drawings in which:

FIG. 1 is a top plan view of a swather tractor having a swath roller attachment according to the present invention.

FIG. 2 is a top plan view of the rear end only of the tractor of FIG. 1 showing the swath roller attachment in enlarged view.

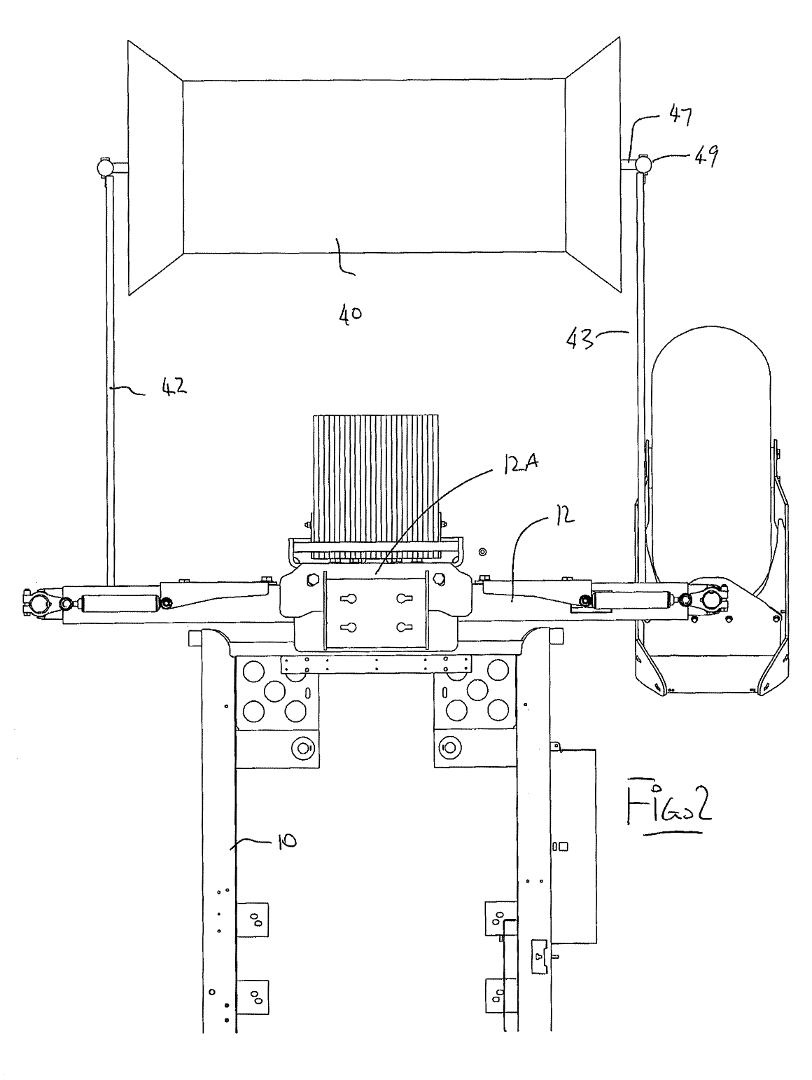

FIG. 3 is a side elevational view of the rear end only of the tractor of FIG. 1 showing the swath roller attachment.

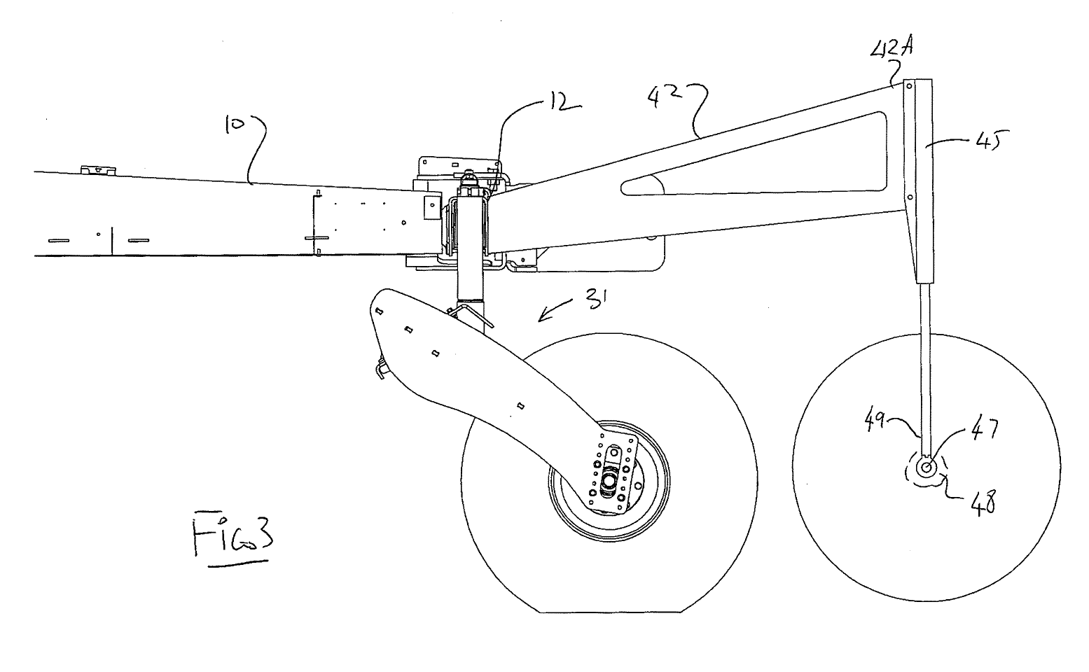

FIG. 4 is an isometric view of the rear end of the tractor and the swath roller attachment.

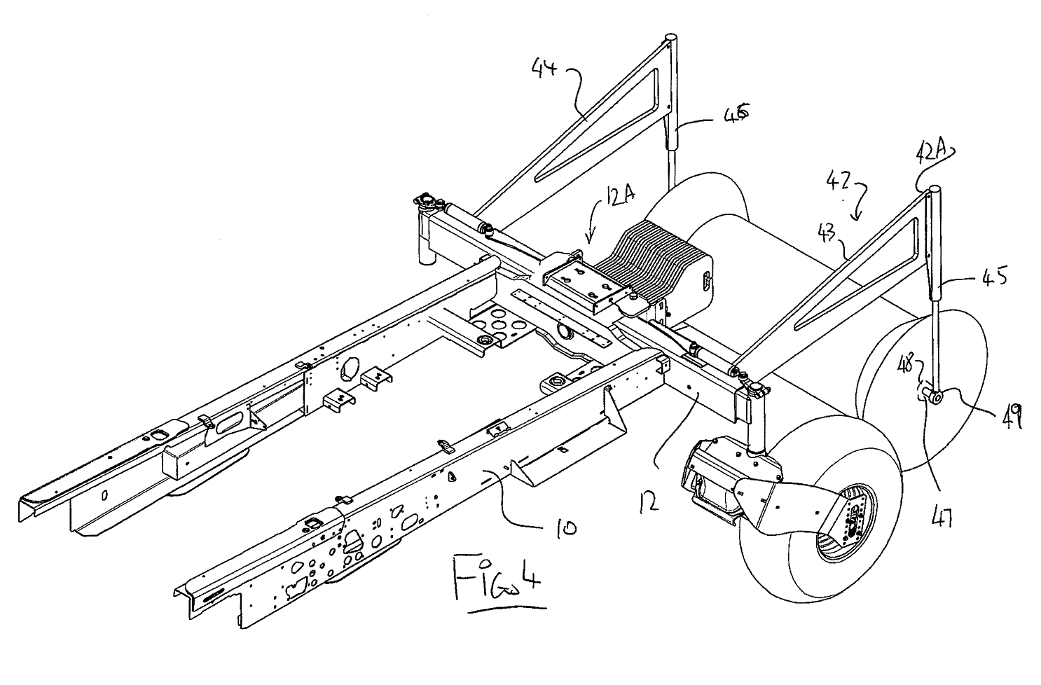

In the drawings like characters of reference indicate corresponding parts in the different figures.

### DETAILED DESCRIPTION

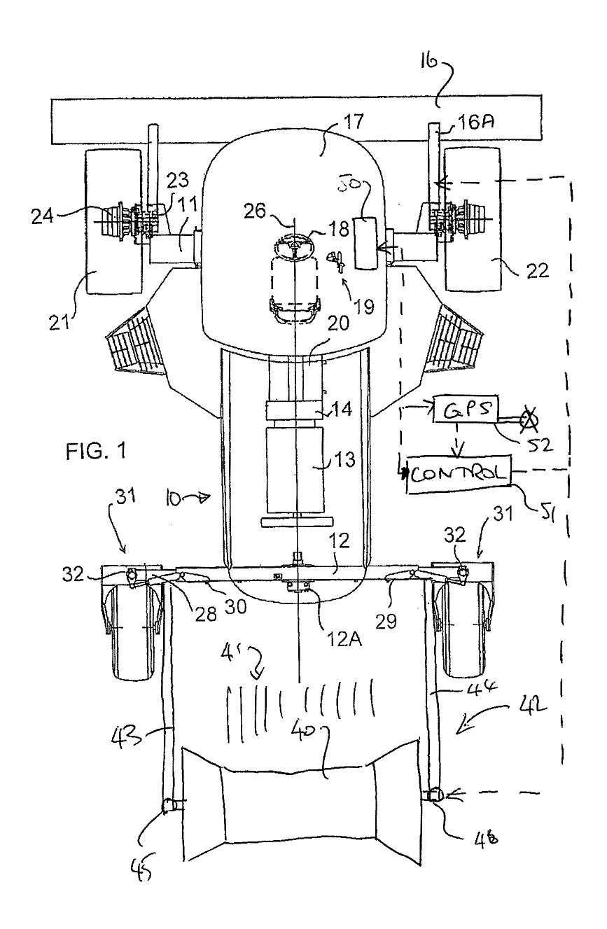

In FIG. 1 is shown a swather tractor of the above type which includes a frame 10 with a front axle 11 and a rear axle 12. On the frame 10 is mounted a motor 13 driving a gear box and pump assembly schematically indicated at 14 for communicating hydraulic drive fluid to the various components of the tractor for propelling the tractor and for driving a header 16 mounted on the tractor. In one example, the engine drives a gearbox at the rear of the engine that splits the power to two pump assemblies. One pump assembly has two pumps (one for each wheel) for traction drive and each pump controls one wheel. The other pump assembly has four pumps (two for header drive, one for lift functions and one providing supercharge oil). In the embodiment shown the header 16 for cutting a standing crop is carried on support arms 16A mounted on the tractor at the forward end in conventional manner which provide a floating and lifting actin for the header. The tractor includes a cab 17 including steering 18 and control elements 19 operable by the driver with those control elements and steering acting to communicate control movements to a fluid control system generally indicated at 20 which supplies the fluid to the various elements to be driven.

The tractor includes first wheels 21 and 22 mounted on legs 23 extending downwardly from the front axle 11. Each leg carries a drive motor 24 for providing drive power to the respective wheel 21, 22 in response to the supply of hydraulic fluid from the control unit 20. The wheels 21 and 22 are mounted on hubs attached to the motors 24 so that the wheels are supported at a fixed angle to the frame so as to be parallel to each other and parallel to a center line 26 of the tractor. Thus the tractor is not steered by pivotal movements of the wheels which are fixed.

The rear axle 12 is mounted for pivotal movement on a center pivot 12A defining a horizontal axis longitudinal of the center line of the tractor so as to form what is commonly known as a walking beam. At the outer end 28, 29 of the axle 12 is mounted a respective castor wheel 31 which can swivel around a vertical pivot member 32 of the castor. Thus the wheels on the axle 12 are castor wheels which are again not steered but merely free to rotate around the vertical axis defined by the pivot 32. The wheels can also include independent suspensions systems of the type shown in U.S. Pat. No. 8,020,648 (Otto) issued Sep. 20, 2011 to the present assignees.

Tractors of this type are well known and are highly maneuverable since the steering is effected by differential speed or differential rotation of the wheels 21 and 22 with the castor wheels 31 merely following the steering action as required. It is well known that such tractors are generally used with the driven wheels 21 and 22 forward so that the implement is in front of those wheels.

In the present invention there is provided a swath roller 40 for rolling on the swath 4 formed by the header and fed between the rear wheels 31. The swath roller is carried on a mounting assembly 42 attaching the swath roller to the tractor for forward movement with the tractor. The mounting assembly is rigidly attached to a component of the tractor, which as shown is the rear walking beam 12 such that the mounting assembly is held at a set position relative to the tractor determined by a position of the component and the swath roller 40 is not pivotally or rotatably mounted relative to the tractor.

Alternatively the mounting assembly can be directly attached to the frame of the tractor or, in cases where the rear beam 12 is fixed to the frame, to the rear beam.

The mounting assembly includes a pair of arms 43, 44 rigidly attached to the axle 12 of the tractor and extending rearwardly from the tractor so that the arms 43, 44 move with the tractor and are not rotatably or pivotally mounted relative to the tractor. Each of the arms has a forward end welded or attached to the beam 12 and extends therefrom rearwardly to a rear end 42A. The arms are cantilevered from the beam 12 and include no cross members so that the arms form the structure for supporting the roller without any frame.

The assembly further includes a pair of depending cylinders 45, 46 attached to the arms at the rear end of the arms and carrying the swath roller at a lower end of the cylinders. The cylinders are fixed to the mounting assembly that is the arms 43, 44 to prevent pivotal or rotatable mounting of the swath roller on the tractor so that the location of the swath roller does not pivot or rotate relative to the tractor. The depending cylinders are double or single acting cylinders extendible along their length so that they are extendible to raise and lower the swath roller relative to the mounting assembly and hence relative to the tractor.

The cylinders provide a floating action by retracting in response to loads from the swath roller greater than a set value. This is typically carried out by providing an accumulator which receives fluid from the cylinders when the pressure within the cylinders exceeds a set value determined by the accumulator.

The lower ends 49 of the cylinders carry a transverse axle 47 extending across between the cylinders and the swath roller includes bearings 48 at each end which are attached to the mounting assembly at the axle 47. The swath roller can be formed of metal or plastic molding as preferred. Pressure from the roller on the swath 41 can be provided by the weight of the roller or by pressure from the cylinders.

The cylinders 45, 46 can be operated by a fluid control system to act as a lifting assembly for lifting the swath roller upward from the swath so that in a raised position the swath roller is free from the swath for passage over the swath. The operation of the lifting cylinders 45, 46 for the swath roller is effected by a control unit 51 of the tractor for controlling lifting of the header from the working position to a raised position thereof.

The control unit 51 can be actuated by a control 50 in the cab which can be under direct driver control or which can be arranged to lift the swath roller to the raised position thereof when the header is raised to the raised position thereof. Thus the driver uses the control 50 to operate the control of the header and this operation automatically acts to lift the swath roller. Thus the driver can raise the header for movement of the tractor over the swath at a turn or other maneuvering situation and can lower the header when cutting is to be continued and the swath roller is automatically raised and lowered at the same times.

Thus for example the control unit can be mechanically operated in that the swath roller is raised and lowered by a hydraulic valve block to divert oil flow to hydraulic cylinders of the lifting assembly of the swath roller. Alternatively the system can be soft-ware controlled by the control unit which operates valves to supply fluid to the lift cylinders as required. The swath roller is adjustable in height relative to the ground by the control unit 51 as operated by the driver control system 50 in order to change the pressure on the swath and wherein the control unit is arranged to operate the height adjustment only when the tractor is stationary.

Alternatively the swath roller is raised and lowered by an electric device such as relay triggering electric current to electric actuators of the lifting assembly of the swath roller.

As shown the control unit 51 includes a GPS position sensing system 52 of a conventional arrangement for actuating the raising of the header to halt crop cutting for maneuvering of the tractor with the header raised and for lowering the header to return to the working position at positions determined by the GPS position sensing system such as at the end of a field.

The swath roller is mounted the rear of the tractor behind the rear wheels.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1-20. (canceled)

21. An agricultural tractor comprising:
a tractor frame having a cab;
a header mounted on support members at a forward end of the frame to be moved in a longitudinal working direction across the ground;
the header being arranged in a working position to cut a standing crop and to form a swath of the crop for deposit on the ground behind the tractor;
a first pair of ground wheels mounted on the frame at positions spaced transversely of the frame adjacent the forward end for supporting the tractor adjacent the header;
a second pair of ground wheels mounted on the frame at positions spaced transversely of the frame adjacent a rearward end of the tractor and spaced to allow the passage of the swath between the second pair of wheels;
a swath compression member for compressing the swath;
a mounting assembly for attaching the swath compression member to the tractor for forward movement with the tractor;
a lifting assembly for lifting the swath compression member upward from the swath so that in a raised position the swath compression member is free from the swath for passage over the swath;
wherein the tractor includes a control unit for controlling lifting of the header from the working position to a raised position thereof;
and wherein the control unit is arranged to automatically operate the lifting assembly to lift the swath compression member to the raised position thereof in response to the header being raised to the raised position thereof.

22. The apparatus according to claim 21 wherein there is provided a manually operable control for operation by a driver of the tractor for actuating the raising and lowering of the header by the control unit.

23. The apparatus according to claim 21 wherein the control unit includes a GPS position sensing system for actuating the raising of the compression member at a location determined by the GPS system.

24. The apparatus according to claim 22 wherein the control unit includes a GPS position sensing system for actuating the raising of the compression member at a location determined by the GPS system.

25. An agricultural tractor comprising:
a tractor frame having a cab;
a header mounted on support members at a forward end of the frame to be moved in a longitudinal working direction across the ground;
the header being arranged in a working position to cut a standing crop and to form a swath of the crop for deposit on the ground behind the tractor;
a first pair of ground wheels mounted on the frame at positions spaced transversely of the frame adjacent the forward end for supporting the tractor adjacent the header;
a second pair of ground wheels mounted on the frame at positions spaced transversely of the frame adjacent a rearward end of the tractor and spaced to allow the passage of the swath between the second pair of wheels;
a swath compression member for compressing the swath;
a mounting assembly for attaching the swath compression member to the tractor for forward movement with the tractor;
a lifting assembly for lifting the swath compression member upward from the swath so that in a raised position the swath compression member is free from the swath for passage over the swath;
wherein there is provided a GPS position sensing system and wherein the lifting assembly for lifting the swath compression member is operated at positions determined by the GPS position sensing system.
